(19) United States
(12) Patent Application Publication
(10) Pub. No.: US 2010/0162670 A1
(43) Pub. Date: Jul. 1, 2010

(54) STIRRUP

(75) Inventor: Hayden Gregory Bostock, Victoria (AU)

Correspondence Address: HARNESS, DICKEY & PIERCE, P.L.C., P.O. BOX 828, BLOOMFIELD HILLS, MI, 48303, US

(73) Assignee: BBL INTERNATIONAL PTY LTD, Scoresby, Victoria (AU)

(21) Appl. No.: 12/523,651

(22) PCT Filed: Jan. 17, 2008
(86) PCT No.: PCT/AU08/00060

§ 371 Date: Jan. 28, 2010

(30) Foreign Application Priority Data
Jan. 18, 2007 (AU) 2007900239

(51) Int. Cl. B68C 3/02

(52) U.S. Cl. 54/49

(57) ABSTRACT

A stirrup including a hanger part for suspending the stirrup and a platform part for supporting a foot of a rider, wherein the hanger part and platform part have interconnecting components, one of the components having an upwardly angled section and the other of the components having a downwardly angled section, the sections cooperating under weight load of the rider to secure the parts together.

### FIELD OF THE INVENTION

This invention relates to a stirrup, and more particularly, but not exclusively, to an improved horse riding stirrup having a release mechanism to provide automatic dismantling of the stirrup in the event of an accident to prevent the rider being dragged by his/her mount.

### BACKGROUND OF THE INVENTION

It is known to provide a safety stirrup which prevents a rider's foot being retained by the stirrup in the event of the rider being dismounted or thrown from a horse. One such stirrup is shown in U.S. Pat. No. 6,698,169 also in the name of the present Applicant.

The stirrup of U.S. Pat. No. 6,698,169 has an arrangement wherein an inner part of the stirrup is coupled to the outer part of the stirrup by way of projections at either side of the inner part being lodged within channels formed in opposed arms of the outer part. The inner part also has cylindrical projections which rest within indentations formed in the outer part to retain the stirrup in an operating configuration.

Examples of the present invention seek to provide an improved safety stirrup which is more compact, has greater load-bearing capacity and/or has a more unitary structure than previously proposed safety stirrups.

### SUMMARY OF THE INVENTION

In accordance with one aspect of the present invention, there is provided a stirrup including a hanger part for suspending the stirrup and a platform part for supporting a foot of a rider, wherein the hanger part and platform part have interconnecting components, one of the components having an upwardly angled section and the other of the components having a downwardly angled section, the sections cooperating under weight load of the rider to secure the parts together.

Preferably, the platform part is adapted to be removably coupled to the hanger part and to become uncoupled from the hanger part in response to application of a threshold rotational force to the platform part.

Preferably, the hanger part includes opposed suspending arms for supporting either side of the platform part.

Preferably, said one interconnecting component is a lug with a reverse taper which defines the upwardly angled section, and the other interconnecting component includes a groove defined by a downwardly angled upper flange, whereby the upwardly angled section and the downwardly angled flange cooperate under load when the stirrup is in a normal operating configuration to force the parts into engagement.

Preferably, each of the arms has one of the inwardly extending reverse tapered lugs, and each side of the platform part has one of the interconnecting grooves correspondingly located on an outwardly facing surface thereof. More preferably, each of the lugs has a curved, downwardly angled bottom section forming a locking tab adapted for engagement with a correspondingly curved, upwardly angled lower shoulder of the respective groove.

In a preferred example, the interconnecting components form pivots at either side of the platform part, and the platform part is able to rotate about the pivots from the normal operating configuration to a release configuration in which the lugs are able to slide from the grooves thereby uncoupling the platform part from the hanger part.

Preferably, at least one of the arms has a projection for mating with a respective detent formed on the platform part when in the normal operating configuration, and the threshold force is required to deform the material of the stirrup to displace the projections from the detents.

In a preferred example, the platform part forms at least a portion of outer side walls of the stirrup beneath the pivots. More preferably, an outside surface of the platform part is flush with an outside surface of the hanger part when in the normal operating configuration.

In accordance with another aspect of the present invention, there is provided a stirrup including a hanger part for suspending the stirrup and a platform part for supporting a foot of a rider, wherein the hanger part and platform part have interconnecting components forming a pivot about which the platform part rotates relative to the hanger part, and wherein the platform part forms at least a portion of outer side walls of the stirrup beneath the pivot.

### BRIEF DESCRIPTION OF THE DRAWINGS

The invention is described, by way of non-limiting example only, with reference to the accompanying drawings in which:

FIG. 1 is a perspective view of a stirrup in accordance with an example, shown in a normal operating configuration;

FIG. 2 is a perspective view of the stirrup, showing a platform part of the stirrup being rotated relative to a hanger part of the stirrup;

FIG. 3 is a perspective view of the stirrup, showing the platform part being uncoupled from the hanger part;

FIG. 4 is a cross-sectional side view of a side wall of the stirrup, shown in the same configuration as in FIG. 1;

FIG. 5 is a cross-sectional side view of a side wall of the stirrup, shown in the same configuration as in FIG. 2;

FIG. 6 is a cross-sectional side view of a side wall of the stirrup, shown in the same configuration as in FIG. 3;

FIG. 7 is a lower perspective view of the stirrup, shown with the platform part separated from the hanger part;

FIG. 8 is a cross-sectional front view of the stirrup, shown in a normal operating configuration as in FIGS. 1 and 4; and

FIG. 9 is a detailed cross-sectional view showing a projection on an inside wall of the hanger part mating with a detent formed in the platform part.

### DETAILED DESCRIPTION

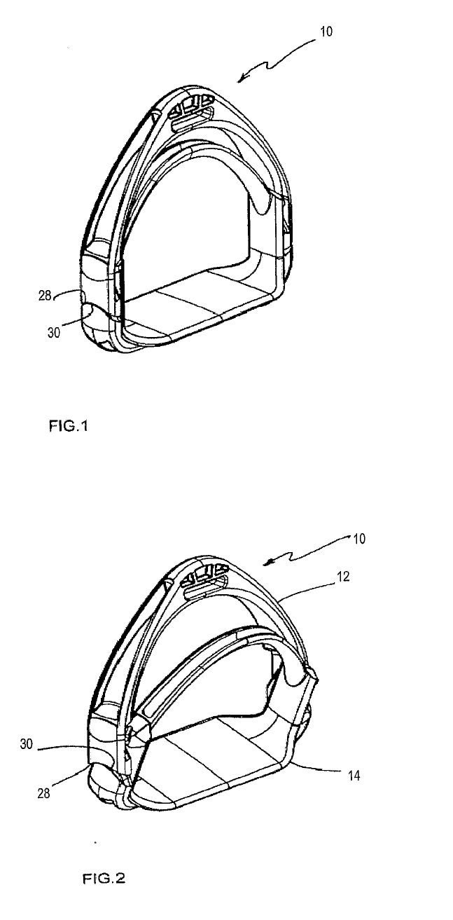

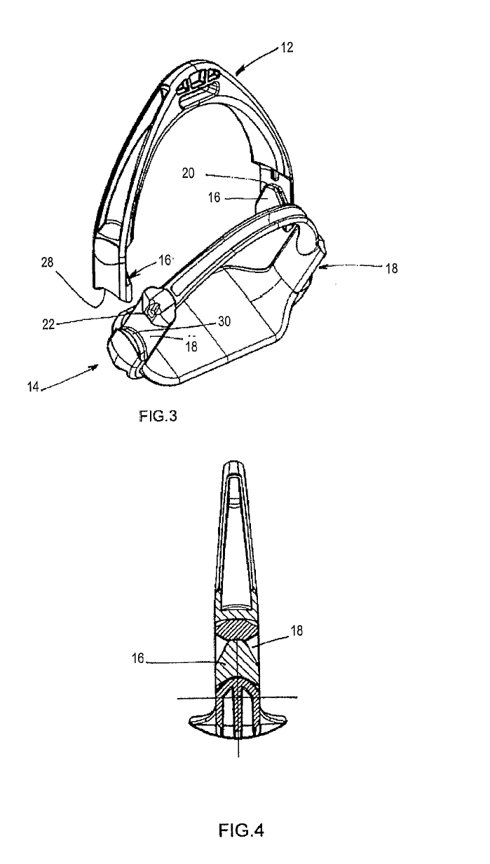

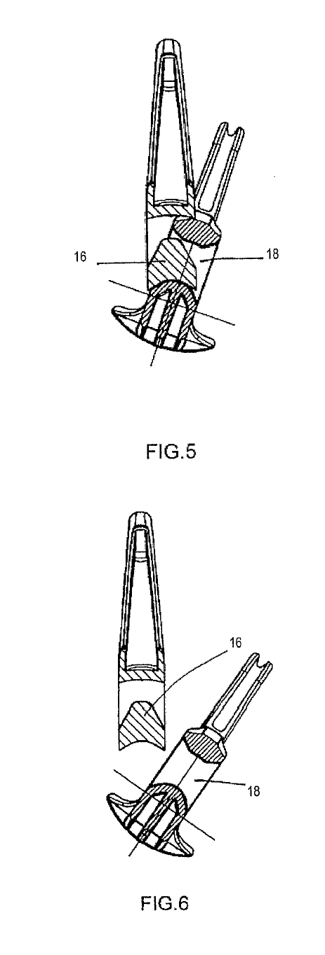

A stirrup 10 in accordance with an example of the invention is shown in FIGS. 1 to 9 of the drawings. The stirrup 10 includes a hanger part 12 for suspending the stirrup 10 and a platform part 14 for supporting a foot of a rider. The hanger part 12 and platform part 14 have interconnecting components 16, 18 which cooperate under weight load of the rider to secure the parts 12, 14 together.

More particularly, the hanger part 12 has an interconnecting component in the form of a lug 16 having an upwardly angled section 20, and the platform part 14 has an interconnecting component including a groove 18 defined by a downwardly angled section 22. Due to the angles at which the surfaces of the sections 20, 22 are formed, the sections cooperate under weight load of the rider to secure the parts 12, 14 together by virtue of force being transferred from the downwardly angled section 22 to the upwardly angled section 20.

Advantageously, this securing together of the parts 12, 14 tends to bring the parts 12, 14 into tighter engagement as force is applied, and assists in preventing the hanger part 12 from unintentionally deforming outwardly from the platform part 14, thus avoiding unwanted separation of the stirrup 10 and unwanted loss of support of the rider.

The platform part 14 is adapted to be removably coupled to the hanger part 12 and to become uncoupled from the hanger part 12 in response to application of a threshold rotational force to the platform part 14. The threshold rotational force is predetermined such that the threshold will be exceeded in the event of the rider being thrown from the horse.

The hanger part 12 includes opposed suspending arms 24, 26 for supporting either side of the platform part 14. Each of the arms 24, 26 has a lug 16, and each of the sides of the platform part has a groove 18 formed therein.

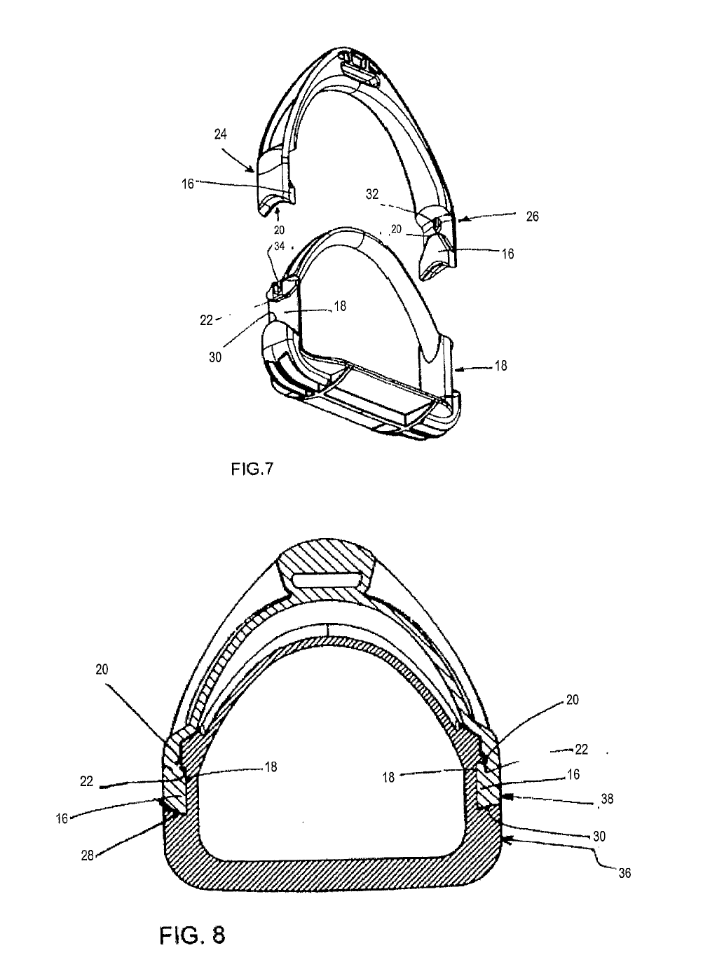

Each of the lugs 16 has a reverse taper cross-sectional profile along a vertical plane, as shown in the cross-sectional view of FIG. 8. This reverse taper of the lugs 16 defines the upwardly angled section 20 at an upper end of the lugs 16, as well as a downwardly angled section 28 at a lower end of the lugs 16. The downwardly angled bottom section 28 is curved, as shown in FIG. 7, and forms a locking tab which engages with a correspondingly curved, upwardly angled lower shoulder 30 of the respective groove 18 when the stirrup is in the normal operating configuration. This interlocking of the bottom section 28 of the lugs 16 with the upwardly angled lower shoulder 30 of the grooves 18 is shown most clearly in FIGS. 1, 2 and 8.

Advantageously, when in the normal operating configuration, force is transferred from the platform part 14 to the hanger part 12 via the lugs 16. Moreover, by virtue of the interlocking of the lugs 16 within the grooves 18 at both the top and bottom of the lugs 16, there is good rigidity and strength in the connection on which the transfer of force depends, this being particularly beneficial in view of the forces to which stirrups are subjected during normal use.

The interconnecting components form pivots at either side of the platform part 14, and the platform part 14 is able to rotate about the pivots from the normal operating configuration to a release configuration in which the lugs 16 are able to slide from the grooves 18 thereby uncoupling the platform part 14 from the hanger part 12. With reference to FIGS. 4 to 6, rotation of the platform part 14 relative to the hanger part 12 is facilitated by the corresponding curvatures of the curved bottom section 28 of the lugs 16 and the curved lower shoulder 30 of the grooves 18.

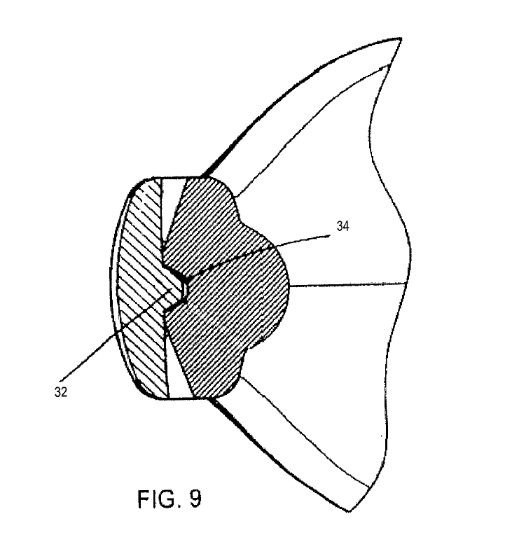

With reference to FIGS. 7 and 9, each of the arms 24, 26 has a projection 32 for mating with a respective detent 34 formed on the platform part 14 when in the normal operating configuration, and the threshold rotational force is required to deform the material of the stirrup 10 to displace the projections 32 from the detents 34. In this way the stirrup 10 is maintained in the normal operating configuration. The threshold rotational force is set by the size and geometry of the projections 32 and detents 34. Ramped lead-in faces on either side of the detents 34 assist in resetting the stirrup 10 after it has been released (ie. in the reverse order of steps shown in FIGS. 1 to 3).

The platform part 14 forms a lower portion of outer side walls of the stirrup 10 beneath the pivots, and an outside surface 36 of the platform part 14 is flush with an outside surface 38 of the hanger part 12 when in the normal operating configuration. Advantageously, this arrangement omits the channels which are present in the arms of previously proposed stirrups, and provides a stirrup which is more unitary in structure and more similar in general appearance to a regular single-piece stirrup. This will likely assist in popularity of the present safety stirrup owing to improved scope for market acceptance and improved useability due to reduced bulkiness.

While an example of the present invention has been described above, it should be understood that it has been presented by way of example only, and not by way of limitation. It will be apparent to a person skilled in the relevant art that various changes in form and detail can be made therein without departing from the spirit and scope of the invention. Thus, the present invention should not be limited by the above described example.

1. A stirrup including a hanger part for suspending the stirrup and a platform part for supporting a foot of a rider, wherein the hanger part and platform part have interconnecting components, one of the components having an upwardly angled section and the other of the components having a downwardly angled section, the sections cooperating under weight load of the rider to secure the parts together.

2. A stirrup as claimed in claim 1, wherein the platform part is adapted to be removably coupled to the hanger part and to become uncoupled from the hanger part in response to application of a threshold rotational force to the platform part.

3. A stirrup as claimed in claim 2, wherein the hanger part includes opposed suspending arms for supporting either side of the platform part.

4. A stirrup as claimed in claim 3, wherein said one interconnecting component is a lug with a reverse taper which defines the upwardly angled section, and the other interconnecting component includes a groove defined by a downwardly angled upper flange, whereby the upwardly angled section and the downwardly angled flange cooperate under load when the stirrup is in a normal operating configuration to force the parts into engagement.

5. A stirrup as claimed in claim 4, wherein each of the arms has one of the inwardly extending reverse tapered lugs, and each side of the platform part has one of the interconnecting grooves correspondingly located on an outwardly facing surface thereof.

6. A stirrup as claimed in claim 5, wherein each of the lugs has a curved, downwardly angled bottom section forming a locking tab adapted for engagement with a correspondingly curved, upwardly angled lower shoulder of the respective groove.

7. A stirrup as claimed in claim 6, wherein the interconnecting components form pivots at either side of the platform part, and the platform part is able to rotate about the pivots from the normal operating configuration to a release configuration in which the lugs are able to slide from the grooves thereby uncoupling the platform part from the hanger part.

8. A stirrup as claimed in claim 7, wherein at least one of the arms has a projection for mating with a respective detent formed on the platform part when in the normal operating configuration, and the threshold force is required to deform the material of the stirrup to displace the projections from the detents.

9. A stirrup as claimed in claim 7, wherein the platform part forms at least a portion of outer side walls of the stirrup beneath the pivots.

10. A stirrup as claimed in claim 9, wherein an outside surface of the platform part is flush with an outside surface of the hanger part when in the normal operating configuration.

11. A stirrup including a hanger part for suspending the stirrup and a platform part for supporting a foot of a rider, wherein the hanger part and platform part have interconnecting components forming a pivot about which the platform part rotates relative to the hanger part, and wherein the platform part forms at least a portion of outer side walls of the stirrup beneath the pivot.

12. A stirrup as claimed in claim 8, wherein the platform part forms at least a portion of outer side walls of the stirrup beneath the pivots.
